(19) United States
(12) Patent Application Publication
(10) Pub. No.: US 2021/0087428 A1
(43) Pub. Date: Mar. 25, 2021

(54) POLYIMIDE PRECURSOR SOLUTION, METHOD FOR PRODUCING POLYIMIDE RESIN FILM, AND METHOD FOR PRODUCING SEPARATOR FOR LITHIUM ION SECONDARY BATTERY

(71) Applicant: FUJI XEROX CO., LTD., Tokyo (JP)

(72) Inventors: Kosuke NAKADA, Kanagawa (JP); Kosaku YOSHIMURA, Kanagawa (JP); Yasunobu KASHIMA, Kanagawa (JP); Hidekazu HIROSE, Kanagawa (JP)

(73) Assignee: FUJI XEROX CO., LTD., Tokyo (JP)

(21) Appl. No.: 16/747,561

(22) Filed: Jan. 21, 2020

(30) Foreign Application Priority Data
Sep. 24, 2019 (JP) 2019-173180

(51) Int. Cl. C09D 179/08; B05D 3/02; C09D 5/00; C09D 7/65; C09D 7/40; C09D 7/20; H01M 2/16

(52) U.S. Cl. CPC C09D 179/08; B05D 3/0254; C09D 5/00; H01M 2/1653; C09D 7/69; C09D 7/70; C09D 7/20; C09D 7/65

(57) ABSTRACT

A polyimide precursor solution includes: a polyimide precursor; an aqueous solvent containing a water-soluble organic solvent and water; and particles, in which the particles have a volume average particle diameter within a range of 2.5 μm to 30 μm, an average circularity within a range of 0.900 to 0.990, and a standard deviation of circularity distribution of less than or equal to 0.1.

### CROSS-REFERENCE TO RELATED APPLICATIONS

This application is based on and claims priority under 35 USC 119 from Japanese Patent Application No. 2019-173180 filed Sep. 24, 2019.

### BACKGROUND

### (i) Technical Field

The present invention relates to a polyimide precursor solution, a method for producing a polyimide resin film, and a method for producing a separator for a lithium ion secondary battery.

### (ii) Related Art

A polyimide resin is a material having excellent characteristics such as mechanical strength, chemical stability, and heat resistance, and polyimide films having the characteristics have been attracting attention.

In some cases, the polyimide films are applied to applications for filters (such as a filtration filter, an oil filter, and a fuel filter), applications for secondary batteries (such as a separator for a lithium secondary battery and a solid electrolyte support in an all-solid battery), and the like.

For example, JP2016-183332A discloses a method for producing a porous polyimide film including: a first step of forming a coated film containing a polyimide precursor solution obtained by dissolving polyimide precursors and an organic amine compound in an aqueous solvent and resin particles which are not dissolved in the polyimide precursor solution, and then drying the coated film to form a coat containing the polyimide precursors and the resin particles; and a second step, which includes processing of removing the resin particles, of heating the coat, and imidizing the polyimide precursors to form a polyimide film.

In addition, JP2012-107144A discloses a method for producing a porous polyimide film including: a varnish production step of mixing polyimide acid or polyimide, silica particles, and a solvent with each other to produce varnish or polymerizing polyimide acid or polyimide in a solvent in which silica particles are dispersed to produce varnish; a composite film production step of producing a film of the varnish produced in the varnish production step on a substrate, and then completing imidization to produce a polyimide-silica composite film; and a silica removal step of removing silica from the polyimide-silica composite film produced in the composite film production step, in which silica particles having a sphericity of 1.0 to 1.1, a particle size distribution index (d25/d75) of less than or equal to 1.5, and an average diameter of 100 to 2,000 nm are used as the silica particles, and a mass ratio of silica to polyimide in the polyimide-silica composite film is set as 2 to 6.

### SUMMARY

A polyimide film is produced using a polyimide precursor solution containing particles, polyimide precursors, and an aqueous solvent and is applied to various applications.

The polyimide film containing particles sometimes contains particles having a large diameter to some extent for the purpose of, for example, controlling optical characteristics of the film. In addition, in a case where the polyimide film is applied to a filter, a hole diameter is sometimes required to be large for the purpose of sieving a target substance. In addition, in a case where the polyimide film is applied to a separator for a lithium ion secondary battery, a large hole diameter is sometimes required from the viewpoint of lithium ion permeability.

However, in a case where particles having a large diameter and nearly true spherical shape are used in the above-described polyimide precursor solution, an intended film strength sometimes cannot be obtained.

Aspects of non-limiting embodiments of the present disclosure relate to a polyimide precursor solution that improves a strength of an obtained film compared to a case where particles having an average particle diameter of 2.5 μm to 30 μm and an average circularity of greater than 0.990 are used.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

The above-described problem is addressed by the following.

According to an aspect of the present disclosure, there is provided a polyimide precursor solution including a polyimide precursor; an aqueous solvent containing a water-soluble organic solvent and water, and particles, in which the particles have a volume average particle diameter within a range of 2.5 μm to 30 μm, an average circularity within a range of 0.900 to 0.990, and a standard deviation of circularity distribution of less than or equal to 0.1.

### BRIEF DESCRIPTION OF THE DRAWINGS

Exemplary embodiments of the present invention will be described in detail based on the following figures, wherein:

FIG. 1 is a schematic diagram showing a porous polyimide film as an example of a form of a polyimide film of the present exemplary embodiment;

FIG. 2 is a partial cross-sectional schematic diagram showing an example of a lithium ion secondary battery to which a separator for a lithium ion secondary battery produced by a method for producing a separator for a lithium ion secondary battery according to the present exemplary embodiment is applied; and

FIG. 3 is a partial cross-sectional schematic diagram showing an example of an all-solid battery to which the polyimide film of the present exemplary embodiment is applied.

### DETAILED DESCRIPTION

Hereinafter, an exemplary embodiment of the present invention will be described in detail.

In the present exemplary embodiment, the “film” is a concept including not only a generally called “membrane”, but also generally called “film” and “sheet”.

Polyimide Precursor Solution

A polyimide precursor solution according to the present exemplary embodiment includes: a polyimide precursor; an aqueous solvent containing a water-soluble organic solvent and water; and particles, in which the particles have an average particle diameter of 2.5 μm to 30 μm, an average circularity of 0.900 to 0.990, and a standard deviation of circularity distribution of less than or equal to 0.1.

By allowing the polyimide precursor solution according to the present exemplary embodiment to have the above-described configuration, a polyimide precursor solution that improves the strength of an obtained film is obtained. Although the reason is unclear, it is assumed as follows.

The polyimide precursor solution according to the present exemplary embodiment contains deformed particles having an average circularity of 0.900 to 0.990. Therefore, in films (that is, films including a film before and after an imidization treatment, a film containing particles, a porous film from which particles are removed, and the like) produced using the polyimide precursor solution according to the present exemplary embodiment, a skeleton of a resin portion between particles or between holes is non-uniform, and there is a portion with a thick skeleton and a portion with a thin skeleton. It is considered that the film strength is further improved in a case where the portion with thick skeleton is present at an optimum proportion in the entire film than a case where, for example, a resin portion which is produced using truly spherical particles and has a uniform skeleton is present in the entire film.

Polyimide Precursor Solution

Polyimide Precursor

The polyimide precursor solution of the present exemplary embodiment contains a polyimide precursor.

The polyimide precursor is a resin (polyimide precursor) having a repeating unit represented by General Formula (I).

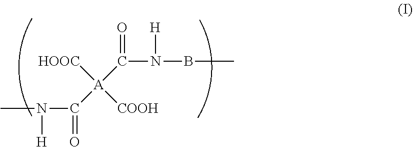

(In General Formula (I), A represents a tetravalent organic group, and B represents a divalent organic group.)

Here, the tetravalent organic group represented by A in General Formula (I) is a residue obtained by removing four carboxyl groups from tetracarboxylic acid dianhydride as a raw material.

On the other hand, the divalent organic group represented by B is a residue obtained by removing two amino groups from a diamine compound as a raw material.

That is, the polyimide precursor having a repeating unit represented by General Formula (I) is a polymer of tetracarboxylic acid dianhydride and a diamine compound.

Examples of tetracarboxylic acid dianhydride include either an aromatic compound or an aliphatic compound, and for example, may be an aromatic compound. That is, for example, the tetravalent organic group represented by A in General Formula (I) may be an aromatic organic group.

Examples of aromatic tetracarboxylic acid dianhydride include pyromellitic acid dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic acid dianhydride, 2,3,6,7-naphthalene tetracarboxylic acid dianhydride, 3,3′,4,4′-biphenyl ether tetracarboxylic acid dianhydride, 3,3′,4,4′-dimethyldiphenylsilane tetracarboxylic acid dianhydride, 3,3′,4,4′-tetraphenylsilane tetracarboxylic acid dianhydride, 1,2,3,4-furantetracarboxylic acid dianhydride, 4,4′-bis(3,4-dicarboxyphenoxy) diphenylsulfide dianhydride, 4,4′-bis(3,4-dicarboxyphenoxy) diphenylsulfone dianhydride, 4,4′-bis(3,4-dicarboxyphenoxy) diphenylpropane dianhydride, 3,3′4,4′-perfluoroisopropylidenediphthalic acid dianhydride, 3,3′,4,4′-biphenyltetracarboxylic acid dianhydride, 2,3,3′,4′-biphenyltetracarboxylic acid dianhydride, bis(phthalic acid) phenylphosphine oxide dianhydride, p-phenylene-bis(triphenylphthalic acid) dianhydride, m-phenylene-bis(triphenylphthalic acid) dianhydride, bis(triphenylphthalic acid)-4,4′-diphenylether dianhydride, and bis(triphenylphthalic acid)-4,4′-diphenylmethane dianhydride.

Examples of aliphatic tetracarboxylic acid dianhydride include aliphatic or alicyclic tetracarboxylic acid dianhydride such as butanetetracarboxylic acid dianhydride, 1,2,3,4-cyclobutanetetracarboxylic acid dianhydride, 1,3-dimethyl-1,2,3,4-cyclobutanetetracarboxylic acid dianhydride, 1,2,3,4-cyclopentanetetracarboxylic acid dianhydride, 2,3,5-tricarboxycyclopentylacetic acid dianhydride, 3,5,6-tricarboxynorbonane-2-acetic acid dianhydride, 2,3,4,5-tetrahydrofurantetracarboxylic acid dianhydride, 5-(2,5-dioxotetrahydrofuryl)-3-methyl-3-cyclohexene-1,2-di carboxylic acid dianhydride, and bicyclo[2,2,2]-oct-7-ene-2,3,5,6-tetracarboxylic acid dianhydride; and aromatic ring-containing aliphatic tetracarboxylic acid dianhydride such as 1,3,3a,4,5,9b-(hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione.

Among these, as tetracarboxylic acid dianhydride, for example, aromatic tetracarboxylic acid dianhydride is preferable. Specifically, for example, pyromellitic acid dianhydride, 3,3′,4,4′-biphenyltetracarboxylic acid dianhydride, 2,3,3′,4′-biphenyltetracarboxylic acid dianhydride, 3,3′,4,4′-biphenyl ether tetracarboxylic acid dianhydride, and 3,3′,4,4′-benzophenone tetracarboxylic acid dianhydride are preferable, pyromellitic acid dianhydride, 3,3′,4,4′-biphenyltetracarboxylic acid dianhydride, and 3,3′,4,4′-benzophenone tetracarboxylic acid dianhydride are more preferable, and 3,3′,4,4′-biphenyltetracarboxylic acid dianhydride is particularly preferable.

Tetracarboxylic acid dianhydride may be used alone or in combination of two or more thereof.

In addition, in a case where two or more thereof are used in combination, aromatic tetracarboxylic acid dianhydride or aliphatic tetracarboxylic acid may be used in combination, or aromatic tetracarboxylic acid dianhydride and aliphatic tetracarboxylic acid dianhydride may be combined.

On the other hand, the diamine compound is a diamine compound having two amino groups in a molecular structure. Examples of the diamine compound include either an aromatic compound or an aliphatic compound, and for example, may be an aromatic compound. That is, the divalent organic group represented by B in General Formula (I) may be for example, an aromatic organic group.

Examples of diamine compound include aromatic diamines such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl) hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl) biphenyl, 2,2-bis[4-(4-aminophenoxy) phenyl] propane, 2,2-bis[4-(4-aminophenoxy) phenyl] hexafluoropropane, 1,4-bis(4-aminophenoxy) benzene, 4,4′-bis(4-aminophenoxy)-biphenyl, 1,3′-bis(4-aminophenoxy) benzene, 9,9-bis(4-aminophenyl) fluorene, 4,4′-(p-phenyleneisopropylidene) bisaniline, 4,4′-(m-phenyleneisopropylidene) bisaniline, 2,2′-bis[4-(4-amino-2-trifluoromethylphenoxy) phenyl]hexafluoropropane, and 4,4′-bis[4-(4-amino-2-trifluoromethyl) phenoxy]-octafluorobiphenyl; aromatic diamines, such as diaminotetraphenylthiophene, which has two amino groups bound to an aromatic ring and has a heteroatom other than a nitrogen atom of the amino groups; aliphatic and alicyclic diamines such as 1,1-metaxylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoin danylene dimethylenediamine, tricyclo[6,2,1,0^{2.7}]-undecylenedimethyldiamine, and 4,4′-methylene-bis(cyclohexylamine).

Among these, as a diamine compound, for example, an aromatic diamine compound is preferable. Specifically, for example, p-phenylenediamine, m-phenylenediamine, 4,4′-diaminodiphenylmethane, 4,4′-diaminodiphenyl ether, 3,4′-diaminodiphenyl ether, 4,4′-diaminodiphenyl sulfide, and 4,4′-diaminodiphenylsulfone are preferable, and 4,4′-diaminodiphenyl ether and p-phenylenediamine are particularly preferable.

The diamine compound may be used alone or in combination of two or more thereof. In addition, in a case where two or more thereof are used in combination, an aromatic diamine compound or an aliphatic diamine compound may be used in combination, or an aromatic diamine compound or an aliphatic diamine compound may be combined.

The weight average molecular weight of the polyimide precursor used in the present exemplary embodiment is, for example, preferably 5,000 to 300,000 and more preferably 10,000 to 150,000.

The weight average molecular weight of the polyimide precursor is measured through a gel permeation chromatography (GPC) method under the following measurement conditions.
Column: TOSOH TSKgelα-M (7.8 mm I.D×30 cm)
Eluent: DMF (dimethylformamide)/30 mM LiBr/60 mM phosphoric acid
Flow rate: 0.6 mL/min
Injection amount: 60 μL
Detector: RI (differential refractive index detector)

The content of the polyimide precursor contained in the polyimide precursor solution according to the present exemplary embodiment may be for example, 0.1 mass % to 40 mass % based on the total mass of the polyimide precursor solution, and is, preferably 1 mass % to 25 mass %.

Particles

The polyimide precursor solution of the present exemplary embodiment contains particles which have an average particle diameter of 2.5 μm to 30 μm, an average circularity of 0.900 to 0.990, and a standard deviation of circularity distribution of less than or equal to 0.1.

The particles are not dissolved, but dispersed in the polyimide precursor solution according to the present exemplary embodiment, and a material of the particles is not particularly limited. The particles in the present exemplary embodiment may remain contained in a polyimide film produced using a polyimide precursor solution, or may be removed from a produced polyimide film. The particles are broadly classified into resin particles and inorganic particles to be described below.

Here, in the present exemplary embodiment, the expression “particles are not dissolved” means that particles are dissolved in a target liquid within a range of less than or equal to 3 mass % at 25° C. in addition to that particles are not dissolved in a target liquid.

In the present exemplary embodiment, the average particle diameter of particles is a value of a volume average particle diameter D50v measured through a method to be described below.

The volume average particle diameter D50v of particles is, for example, preferably 4 μm to 28 μm from the viewpoint of improving the strength of a film to be obtained.

The volume particle size distribution index (GSDv) of particles is, for example, preferably less than or equal to 1.30, more preferably less than or equal to 1.25, and most preferably less than or equal to 1.20. The volume particle size distribution index of particles is calculated as (D84v/D16v)^{1/2} from the particle size distribution of the particles in a particle-dispersed polyimide precursor solution.

The particle size distribution of particles in the polyimide precursor solution according to the present exemplary embodiment is measured as follows. A solution to be measured is diluted, and the particle size distribution of particles in the solution is measured using COULTER COUNTER LS13 (manufactured by Beckman Coulter Inc.). The particle size distribution is measured based on the measured particle size distribution by drawing volume cumulative distribution from a small diameter side with respect to divided particle size ranges (channels).

Of the volume cumulative distribution drawn from the small diameter side, the particle diameter with 16% of accumulation is set as a volume particle diameter D16v, the particle diameter with 50% of accumulation is set as a volume average particle diameter D50v, and the particle diameter with 84% of accumulation is set as a volume particle diameter D84v.

In a case where it is difficult to measure the volume particle size distribution of particles in the polyimide precursor solution of the present exemplary embodiment through the above-described method, it is measured through a method such as a dynamic light scattering method.

The average circularity of particles contained in the polyimide precursor solution according to the present exemplary embodiment is, for example, preferably 0.905 to 0.988 and more preferably 0.910 to 0.980 from the viewpoint of improving the strength of a film to be obtained.

The average circularity of particles is a value measured through the following method.

Particles are analyzed using a flow type particle image analyzer (manufactured by Sysmex Corporation, FPIA-3000), circularity=(peripheral length of circle having same area as image of particle projection image)+(peripheral length of particle projection image) is obtained, and the circularity with 50% of accumulation from a small side in circularity distribution of 3,000 particles is set as an average circularity of the particles.

The standard deviation of circularity distribution of particles contained in the polyimide precursor solution according to the present exemplary embodiment is, for example, preferably less than or equal to 0.07 and more preferably less than or equal to 0.06 from the viewpoint of improving the strength of a film to be obtained. A lower limit value of the standard deviation of the circularity distribution of particles is not particularly limited, but an example thereof includes greater than or equal to 0.01.

The average circularity is calculated using a device measured the above-described circularity, and the standard deviation is calculated using the average circularity.

Specifically, the standard deviation is a value obtained by calculating the difference between the value of the average circularity and a value (n number=250) of circularity of each particle and raising the sum of squared values thereof to the power of (½).

Either resin particles or inorganic particles may be used as particles, but it is preferable to use, for example, resin particles.

With resin particles, nearly spherical particles (that is, particles satisfying the average circularity of the particles of the present exemplary embodiment) are easily produced through a well-known production method such as emulsion polymerization as will be described below.

Furthermore, since the resin particles and the polyimide precursor are organic materials, the particle dispersibility in a coated film or the interface adhesion between polyimide precursors are easily improved compared to a case where inorganic particles are used. In addition, when producing a porous polyimide film, a porous polyimide film having almost uniform holes and hole diameters is easily obtained. For example, it is preferable to use resin particles for the reasons.

Examples of inorganic particles include silica particles. For example, silica particles are inorganic particles, from the viewpoint that nearly spherical particles are available. For example, it is possible to obtain a porous polyimide film of which holes are nearly spherical using a polyimide precursor solution with nearly spherical silica particles. However, in the case where silica particles are used as particles, it is difficult to absorb volumetric shrinkage in an imidization step. Therefore, there is a tendency that fine cracks are likely to occur in the polyimide film after the imidization. For example, it is preferable to use resin particles as particles in this respect.

For example, the polyimide precursor solution according to the present exemplary embodiment preferably contain particles at a volume ratio of 40% to 80%, more preferably at a volume ratio of 50% to 80%, and still more preferably at a volume ratio of 50% to 70% based on the total volume of a solid content of the polyimide precursor and the particles.

A method for measuring the above-described volume ratio is as shown below.

The volume ratio of particles to the total volume of a solid content of the polyimide precursor and the particles indicates a volume ratio of particles occupying a polyimide film produced using the polyimide precursor according to the present exemplary embodiment. The volume ratio of particles occupying a polyimide film is obtained through the following method by observing a cut surface cut along a film thickness direction of the polyimide film with a scanning electron microscope (SEM).

In the SEM image, an arbitrary area S is specified for the polyimide film to obtain a total area A of particles contained in the area S. Assuming that the polyimide film is homogeneous, a value obtained by dividing the total area A of particles by the area S is converted into a percentage (%) and is set as a volume ratio of particles occupying the polyimide film. The area S is set as a sufficiently large area with respect to the size of particles. For example, the size of the area is set so as to contain 100 or more particles. The area S may be a total of plural cut surfaces.

Hereinafter, specific materials for the resin particles and the inorganic particles will be described.

Resin Particles

Specific examples of resin particles include resin particles such as: vinylpolymers represented by polystyrenes, poly(meth)acrylicacids, polyvinylacetate, polyvinylalcohol, polyvinylbutyral, polyvinylether, and the like; condensation polymers represented by polyester, polyurethane, polyamide, and the like; hydrocarbon polymers represented by polyethylene, polypropylene, polybutadiene, and the like; and fluorine polymers represented by polytetrafluoroethylene, polyvinyl fluoride, and the like.

Here, “(meth)acrylic” includes both “acrylic” and “methacrylic”. In addition, the (meth) acrylic acids include (meth)acrylic acid, (meth)acrylic acid ester, and (meth)acrylamide.

Resin particles may be cross-linked or may not be cross-linked. In the case where resin particles are cross-linked, difunctional monomers such as divinylbenzene, ethylene glycol dimethacrylate, nonane diacrylate, and decanediol diacrylate, and polyfunctional monomers such as trimethylolpropane triacrylate and trimethylolpropane trimethacrylate may be used in combination.

In a case where resin particles are vinyl resin particles, monomers are obtained through polymerization. Examples of monomers of vinyl resins include monomers shown below.

Examples thereof include vinyl resin units obtained by polymerizing monomers such as: styrenes, such as styrene, alkyl-substituted styrene (for example, α-methylstyrene, 2-methylstyrene, 3-methylstyrene, 4-methylstyrene, 2-ethylstyrene, 3-ethylstyrene, and 4-ethylstyrene), halogen-substituted styrene (for example, 2-chlorostyrene, 3-chlorostyrene, and 4-chlorostyrene), and vinylnaphthalene, which have a styrene skeleton; (meth)acrylic acid esters such as methyl (meth)acrylate, ethyl (meth)acrylate, n-propyl (meth)acrylate, n-butyl (meth)acrylate, lauryl (meth)acrylate, and 2-ethylhexyl (meth)acrylate; vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, and vinyl isopropenyl ketone; acids such as (meth)acrylic acid, maleic acid, cinnamic acid, fumaric acid, and vinyl sulfonic acid; and bases such as ethyleneimine, vinyl pyridine, and vinyl amine.

Monofunctional monomers such as vinyl acetate may be used in combination as other monomers.

In addition, a vinyl resin may be a resin using the monomers alone, or may be a resin that is a copolymer using two or more monomers.

For example, resin particles are preferably resin particles of polystyrenes (also referred to as “styrene resins”), poly(meth)acrylic acids (also referred to as “(meth)acrylic resins”), and polyesters (also referred to as “polyester resins”) from the viewpoints of productivity, and adaptability of a particle removal step to be described below. Specifically, resin particles of polystyrene, styrene-(meth)acrylic acid copolymers, and poly(meth)acrylic acids are more preferable, and resin particles of polystyrene and poly(meth)acrylic acid esters are most preferable. The resin particles may be used alone or in combination of two or more thereof.

A styrene resin contains a styrene monomer (monomer having a styrene skeleton) as a constitutional unit. When the total composition in a polymer is set as 100 mol %, the constitutional unit is, for example, preferably greater than or equal to 30 mol % and more preferably greater than or equal to 50 mol %.

In addition, a (meth)acrylic resin means a methacrylic resin and an acrylic resin and contains (meth)acrylic monomers (monomer having a (meth)acryloyl skeleton) as constitutional units, and the total ratio of a constitutional unit derived from (meth)acrylic acid and a constitutional unit derived from (meth)acrylic acid ester is, for example, preferably greater than or equal to 30 mol % and more preferably greater than or equal to 50 mol % when the total composition in a polymer is set as 100 mol %.

In addition, a polyester resin is a polymer compound having an ester bond in a molecular chain.

In resin particles, for example, it is preferable that the shape of particles is maintained in a process of producing the polyimide precursor solution according to the present exemplary embodiment or in a process of performing coating with a polyimide precursor solution when producing a polyimide film and drying the coated film (before removal of the resin particles). From this viewpoint, a glass transition temperature of resin particles may be higher than or equal to 60° C. and is, for example, preferably higher than or equal to 70° C. and more preferably higher than or equal to 80° C.

The glass transition temperature is obtained from a differential scanning calorimetry (DSC) curve obtained through DSC, and is more specifically obtained from an “extrapolation glass transition start temperature” described in a method for obtaining the glass transition temperature in “Method for Measuring Transition Temperature of Plastic” of JIS K 7121-1987.

Inorganic Particles

Specific examples of inorganic particles include inorganic particles such as silica (silicon dioxide) particles, magnesium oxide particles, alumina particles, zirconia particles, calcium carbonate particles, calcium oxide particles, titanium dioxide particles, zinc oxide particles, and cerium oxide particles. For example, the shape of particles may be nearly spherical as described above. In this respect, inorganic particles are, for example, preferably inorganic particles such as silica particles, magnesium oxide particles, calcium carbonate particles, magnesium oxide particles, and alumina particles, more preferably inorganic particles such as silica particles, titanium oxide particles, and alumina particles, and still more preferably silica particles. The inorganic particles may be used alone or in a combination of two or more thereof.

In a case where dispersibility and wettability of inorganic particles to a solvent of a polyimide precursor solution are insufficient, the surface of inorganic particles may be modified as necessary. Examples of methods for modifying a surface include a processing method with alkoxysilane which is represented by a silane coupling agent and has an organic group; and a method for performing coating with an organic acid such as oxalic acid, citric acid, and lactic acid.

The content of particles contained in the polyimide precursor solution according to the present exemplary embodiment may be for example, 0.1 mass % to 40 mass % based on the total mass of the polyimide precursor solution and is preferably 0.5 mass % to 30 mass %, more preferably 1 mass % to 25 mass %, and still more preferably 1 mass % to 20 mass %.

Aqueous Solvent

The polyimide precursor solution according to the present exemplary embodiment contains an aqueous solvent containing a water-soluble organic solvent and water.

Water-Soluble Organic Solvent

The aqueous solvent used in the present exemplary embodiment contains a water-soluble organic solvent. Here, the water solubility means that a target substance dissolves in water by 1 mass % or more at 25° C.

Examples of water-soluble organic solvents include an aprotic polar solvent, a water-soluble ether solvent, a water-soluble ketone solvent, and a water-soluble alcohol solvent.

Specific examples of aprotic polar solvents include N-methyl-2-pyrrolidone (NMP), N,N-dimethylformamide (DMF), N,N-1,3-dimethyl-2-imidazolidinone (DMI), N,N-dimethylacetamide (DMAc), N,N-diethylacetamide (DEAc), dimethylsulfoxide (DMSO), hexamethylene phosphoramide (HMPA), N-methylcaprolactam, N-acetyl-2-pyrrolidone, and 1,3-dimethyl-imidazolidone. Among these, for example, N-methyl-2-pyrrolidone (NMP), N,N-dimethylformamide (DMF), N,N-1,3-dimethyl-2-imidazolidinone (DMI), and N,N-dimethylacetamide (DMAc) are preferable as aprotic polar solvents.

The water-soluble ether solvent is a water-soluble solvent having an ether bond in a molecule. Examples of water-soluble ether solvents include tetrahydrofuran (THF), dioxane, trioxane, 1,2-dimethoxyethane, diethylene glycol dimethyl ether, and diethylene glycol diethyl ether. Among these, for example, tetrahydrofuran and dioxane are preferable as water-soluble ether solvents.

The water-soluble ketone solvent is a water-soluble solvent having a ketone group in a molecule. Examples of water-soluble ketone solvents include acetone, methyl ethyl ketone, and cyclohexanone. Among these, for example, acetone is preferable as a water-soluble ketone solvent.

The water-soluble alcohol solvent is a water-soluble solvent having an alcoholic hydroxyl group in a molecule. Examples of water-soluble alcohol solvents include methanol, ethanol, 1-propanol, 2-propanol, tert-butylalcohol, ethylene glycol, monoalkyl ether of ethylene glycol, propylene glycol, monoalkyl ether of propylene glycol, diethylene glycol, monoalkyl ether of diethylene glycol, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, glycerin, 2-ethyl-2-hydroxymethyl-1,3-propanediol, and 1,2,6-hexanetriol. Among these, for example, methanol, ethanol, 2-propanol, ethylene glycol, monoalkyl ether of ethylene glycol, propylene glycol, monoalkyl ether of propylene glycol, diethylene glycol, and monoalkyl ether of diethylene glycol are preferable as water-soluble alcohol solvents.

For example, the water-soluble organic solvent used in the present exemplary embodiment preferably contains an organic amine compound. Hereinafter, the organic amine compound will be described.

Organic Amine Compound

The organic amine compound is a compound which is obtained by subjecting a polyimide precursor (carboxyl group thereof) to form an amine salt to improve solubility to an aqueous solvent thereof and functions as an imidization accelerator as well. Specifically, the organic amine compound may be for example, an amine compound having a molecular weight of less than or equal to 170. The organic amine compound may be for example, a compound excluding a diamine compound as a raw material of a polyimide precursor.

The organic amine compound may be for example, a water-soluble compound. The water solubility means that a target substance dissolves in water by 1 mass % or more at 25° C.

Examples of organic amine compounds include a primary amine compound, a secondary amine compound, and a tertiary amine compound.

Among these, for example, at least one selected from a secondary amine compound or a tertiary amine compound (particularly a tertiary amine compound) may be used as an organic amine compound. In a case where a tertiary amine compound or a secondary amine compound is applied as an organic amine compound (particularly a tertiary amine compound), solubility of a polyimide precursor to a solvent, film-forming properties, and preservation stability of a polyimide precursor solution are easily improved.

In addition, an example of the organic amine compound includes a polyvalent amine compound which is di- or higher valent in addition to a monovalent amine compound. In a case where a polyvalent amine compound which is di- or higher valent is applied, a pseudo-crosslinked structure is easily formed between molecules of a polyimide precursor, and the preservation stability of a polyimide precursor solution is easily improved.

Examples of primary amine compounds include methylamine, ethylamine, n-propylamine, isopropylamine, 2-ethanolamine, and 2-amino-2-methyl-1-propanol.

Examples of secondary amine compounds include dimethylamine, 2-(methylamino)ethanol, 2-(ethylamino)ethanol, and morpholine.

Examples of tertiary amine compounds include 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, and N-alkylpiperidine (for example, N-methylpiperidine and N-ethylpiperidine).

The organic amine compound is, for example, preferably a tertiary amine compound from the viewpoint of obtaining a film having a high strength. In this respect, for example, at least one selected from the group consisting of 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, N-methylpiperidine, or N-ethylpiperidine is more preferable. N-alkylmorpholine is particularly preferably used.

Here, for example, an amine compound (hereinafter, referred to as a “nitrogen-containing heterocyclic amine compound”) having an alicyclic structure or an aromatic cyclic structure having a heterocyclic structure containing nitrogen is preferable as an organic amine compound from the viewpoint of obtaining a film having a high strength. The nitrogen-containing heterocyclic amine compound is, for example, more preferably a tertiary amine compound. That is, the nitrogen-containing heterocyclic amine compound is, for example, more preferably tertiary cyclic amine compound.

Examples of tertiary cyclic amine compounds include isoquinolines (amine compound having an isoquinoline skeleton), pyridines (amine compound having a pyridine skeleton), pyrimidines (amine compound having a pyrimidine skeleton), pyrazines (amine compound having a pyrazine skeleton), piperazines (amine compound having a piperazine skeleton), triazines (amine compound having a triazine skeleton), imidazoles (amine compound having an imidazole skeleton), morpholines ((amine compound having a morpholine skeleton), polyaniline, and polypyridine.

As tertiary cyclic amine compounds, for example, at least one selected from the group consisting of morpholines, pyridines, piperidines, or imidazoles are preferable, and morpholines (amine compounds having a morpholine skeleton) (that is, morpholine compounds) are more preferable from the viewpoint of obtaining a polyimide film in which variation in film thickness is suppressed. Among these, at least one selected from the group consisting of N-methylmorpholine, N-methylpiperidine, pyridine, 1,2-dimethylimidazole, 2-ethyl-4-methylimidazole, or picoline is more preferable, and N-methylmorpholine is more preferable.

The above-described organic amine compound may be used alone or in combination of two or more thereof.

The content ratio of an organic amine compound used in the present exemplary embodiment is, for example, preferably less than or equal to 30% and more preferably less than or equal to 15% based on the total mass of a polyimide precursor solution.

In addition, the lower limit value of the content ratio of the organic amine compound is not particularly limited, but an example thereof includes greater than or equal to 1% with respect to the total mass of the polyimide precursor solution.

The above-described water-soluble organic solvent may be used alone or in combination of two or more thereof.

The boiling point of the water-soluble organic solvent may be for example, less than or equal to 270° C. and is, preferably 60° C. to 250° C. and more preferably 80° C. to 230° C. In a case where the boiling point of the water-soluble organic solvent is within the above-described range, the water-soluble organic solvent hardly remains in a polyimide film, and a polyimide film having a high mechanical strength is easily obtained.

The content ratio of the water-soluble organic solvent used in the present exemplary embodiment is, for example, preferably less than or equal to 30 mass % and more preferably less than or equal to 20 mass % based on the total mass of an aqueous solvent contained in a polyimide precursor solution.

In addition, the lower limit value of the content ratio of the organic amine compound is not particularly limited, but an example thereof includes greater than or equal to 1% with respect to the total mass of the polyimide precursor solution.

Water

The aqueous solvent used in the present exemplary embodiment contains water.

Examples of water include distilled water, ion exchange water, ultrafiltration water, and pure water.

The content ratio of water used in the present exemplary embodiment is, for example, preferably 50 mass % to 90 mass %, more preferably 60 mass % to 90 mass %, and still more preferably 60 mass % to 80 mass % based on the total mass of an aqueous solvent contained in a polyimide precursor solution.

The content of the aqueous solvent contained in the polyimide precursor solution according to the present exemplary embodiment may be for example, 50 mass % to 99 mass % and is, preferably 40 mass % to 99 mass % based on the total mass of the polyimide precursor solution.

Other Additives

A catalyst for promoting an imidization reaction, a leveling material for improving the quality of a formed film, or the like may be contained in the polyimide precursor solution according to the present exemplary embodiment.

A dehydrating agent such as acid anhydride and acid catalysts such as a phenol derivative, a sulfonic acid derivative, and a benzoic acid derivative may be used as catalysts for promoting an imidization reaction.

In addition, the polyimide precursor solution may contain, for example, a conductive material (a conductive material (for example, a volume resistivity of less than 107 Ω·cm) or a semiconductive material (for example, a volume resistivity of 107 Ω·cm to 10³ Ω·cm)) added for imparting conductivity according to the purpose of use of a polyimide film.

Examples of conductive agents include carbon black (for example, acidic carbon black having a pH of less than or equal to 5.0); metal (for example, aluminum or nickel); metal oxide (for example, yttrium oxide or tin oxide); and an ion conductive material (for example, potassium titanate or LiCl). The conductive materials may be used alone or in combination of two or more thereof.

In addition, the polyimide precursor solution may contain inorganic particles added for improving a mechanical strength according to the purpose of use of a polyimide film. Examples of inorganic particles include particulate materials such as silica powder, alumina powder, barium sulfate powder, titanium oxide powder, mica, and talc. In addition, LiCoO₂, LiMn₂O, or the like used as an electrode of a lithium ion battery may be contained therein.

Characteristics of Polyimide Resin Film

Average Film Thickness

The average film thickness of polyimide films produced using the polyimide precursor solution according to the present exemplary embodiment is not particularly limited, and may be selected according to the application. The average film thickness may be, for example, 10 μm to 1,000 μm. The average film thickness may be greater than or equal to 20 μm or greater than or equal to 30 μm, and may be less than or equal to 500 μm or less than or equal to 400 μm.

The average film thickness of polyimide resin films in the present exemplary embodiment is obtained by cutting an obtained polyimide resin film in film thickness directions, observing 10 cut surfaces with a scanning electron microscope (SEM), measuring the film thickness of each of the observed spots from the 10 SEM images, and averaging the obtained 10 measurement values (film thickness).

Method for Producing Resin Film

A method for producing a resin film according to the present exemplary embodiment includes a step of coating a top of a substrate with the previously described polyimide precursor solution to form a coated film; and a step of drying the coated film to form a coat containing the polyimide precursor and the particles.

The resin film according to the present exemplary embodiment includes the coat obtained through the above-described steps, a polyimide film obtained by subjecting the coat to an imidization treatment, and a porous polyimide film from which particles are removed.

Specifically, polyimide contained in the polyimide film is obtained by polymerizing tetracarboxylic acid dianhydride and a diamine compound to produce polyimide precursors, obtaining a solution of the polyimide precursors, and causing an imidization reaction. More specifically, polyimide contained in the polyimide film is obtained by causing an imidization reaction using the polyimide precursor solution according to the present exemplary embodiment. An example of the method includes a method for polymerizing tetracarboxylic acid dianhydride and a diamine compound in the presence of an organic amine compound in an aqueous solvent to generate a resin (polyimide precursor), and obtaining a polyimide precursor solution, but the exemplary embodiment of the invention is not limited to this example.

Method for Producing Polyimide Precursor Solution

The method for producing a polyimide precursor solution according to the present exemplary embodiment is not particularly limited, but an example thereof includes production methods shown below in a case where the polyimide precursor solution contains an organic amine compound.

An example of the method includes a method for polymerizing tetracarboxylic acid dianhydride and a diamine compound in the presence of an organic amine compound in an aqueous solvent to generate a resin (polyimide precursor), and obtaining a polyimide precursor solution.

According to the method, for example, since an aqueous solvent is applied, the method is beneficial in terms of high productivity and simplification of the steps as a polyimide precursor solution is produced in one stage.

Another example thereof includes a method for obtaining a polyimide precursor solution such that tetracarboxylic acid dianhydride and a diamine compound are polymerized in an organic solvent such as an aprotic polar solvent (for example, N-methyl-2-pyrrolidone (NMP)) to produce a resin (polyimide precursor), and then, the resin (polyimide precursor) is put into water or an aqueous solvent such as alcohol to be precipitated, followed by dissolving the polyimide precursor and an organic amine compound in the aqueous solvent.

Hereinafter, an example of a method for producing a resin film according to the present exemplary embodiment will be described.

The method for producing a resin film according to the present exemplary embodiment includes a first step and a second step exemplified below. In addition, a third step exemplified below may be included after the second step.

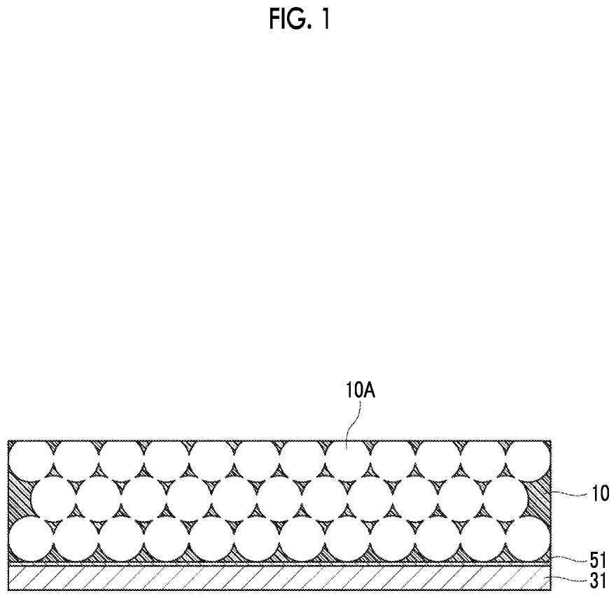

In the description of the production method, the same constituent parts as in FIG. 1 which will be referred to are given of the same reference numerals. In the reference numerals in FIG. 1, 31 represents a substrate, 51 represents a peeling layer, 10A represents a hole, and 10 represents a porous polyimide film (an example of a resin film).

The first step is a step of coating a top of the substrate with the polyimide precursor solution according to the present exemplary embodiment to form a coated film.

The second step is a step of drying the coated film to form a coat containing the polyimide precursors and the particles.

First Step

In the first step, the polyimide precursor solution according to the present exemplary embodiment is prepared.

Next, a top of a substrate is coated with the polyimide precursor solution to form a coated film. The coated film contains a solution containing polyimide precursors, and particles. The particles in the coated film are distributed in a state where aggregation is suppressed.

Thereafter, the coated film formed on the substrate is dried to form a coat containing the polyimide precursors and the particles.

The substrate on which a coat containing polyimide precursors and particles is formed is not particularly limited.

Examples thereof include substrates made of a resin such as polystyrene or polyethylene terephthalate; glass substrates; ceramic substrates; substrates made of metal such as iron or stainless steel (SUS); and composite material substrates in which the materials are combined. In addition, a peeling layer may be provided on a substrate as necessary by performing peeling processing using, for example, a silicone-based or fluorine-based release agent. In addition, roughening the surface of a base material to a size approximately the same as the diameter of particles and promoting exposure of the particles on the contact surface of the base material are also effective.

The method for coating a top of a substrate with a polyimide precursor solution is not particularly limited.

Examples thereof include various methods such as a spray coating method, a spin coating method, a roll coating method, a bar coating method, a slit die coating method, and an ink jet coating method.

In the case of forming a polyimide precursor solution on a substrate, for example, the polyimide precursor solution may be formed by adding an amount of particles to be exposed from the surface of the coated film.

Second Step

The second step is a step of drying the coated film in the first step to form a coat containing polyimide precursors and particles.

After forming the obtained coated film containing polyimide precursors and particles, the coated film is dried to form a coat containing the polyimide precursors and the particles.

Specifically, the coated film containing polyimide precursors and particles is, for example, dried through methods such as heat drying, natural drying, and vacuum drying to form a coat. More specifically, the coated film is dried so that a solvent remaining in a coat becomes less than or equal to 50% (for example, preferably less than or equal to 30%) with respect to the solid content of the coat to form the coat. The coat enters a state in which polyimide precursors can be dissolved in water.

In addition, particles may be exposed by performing processing of exposing particles in the process of drying the coated film after obtaining the coated film to form the coat. The aperture ratio of a porous polyimide film is increased by performing the processing of exposing the particles.

Specific examples of performing processing of exposing particles include methods shown below.

A coat enters a state in which polyimide precursors can be dissolved in water as described above in the process of drying a coated film containing polyimide precursors and particles after obtaining the coated film to form the coat containing the polyimide precursors and the particles. When the coat is in this state, particles can be exposed, for example, through wiping processing or processing of immersing in water. Specifically, a solution which contains polyimide precursors and is present on a particle layer is removed, for example, by performing processing of exposing the particle layer through wiping with water. Particles present in a region (that is, a region on a side away from a substrate of the particle layer) of an upper portion of the particle layer are exposed from the surface of the coat.

In a case of forming a coat on a substrate using a polyimide precursor solution, even in a case where the coat in which particles are buried is formed, the same processing as the above-described processing of exposing particles can be employed as processing of exposing the particles buried in the coat.

The method for producing a polyimide precursor solution is not limited to the above-described production method. From the viewpoint of simplification of steps, for example, it is preferable to synthesize polyimide precursors in an aqueous solvent dispersion obtained by previously dispersing particles which are not dissolved in a solution containing polyimide precursors in an aqueous solvent. A specific example thereof includes the following method.

A particle dispersion is obtained by granulating particles in an aqueous solvent containing water. A polyimide precursor solution is obtained by polymerizing tetracarboxylic acid dianhydride and a diamine compound in the presence of an organic amine compound in a particle dispersion and generating a resin (polyimide precursor).

Examples of methods for producing a polyimide precursor solution further include a method for mixing a solution containing polyimide precursors with dried particles and a method for mixing a solution containing polyimide precursors with a dispersion obtained by previously dispersing particles in an aqueous solvent.

A particle dispersion obtained by previously dispersing particles in an aqueous solvent may be produced as the dispersion in which particles are previously dispersed in an aqueous solvent. A commercially available dispersion obtained by previously dispersing particles in an aqueous solvent may be prepared.

The top of a substrate is coated with the polyimide precursor solution obtained as described above through the above-described method to form a coated film. Thereafter, the coated film is dried to form a coat on the substrate.

Third Step

The third step is a step of imidizing the polyimide precursors contained in the coat obtained in the second step to form a polyimide film. The third step may include processing of removing particles. A porous polyimide film (an example of the “polyimide film”) is obtained through processing of removing particles.

Specifically, in the third step of forming a polyimide film, the coat containing polyimide precursors and particles which has been obtained in the first step is heated to progress imidization, and further heated to form a polyimide film. The imidization has progressed to increase the imidization ratio, but the particles are hardly dissolved in an organic solvent.

In the third step, the processing of removing particles may be performed. Particles may be removed in the process of heating the coat to imidize polyimide precursors, or may be removed from a polyimide film after imidization is completed (after imidization).

In the present exemplary embodiment, the process of imidizing polyimide precursors represents a process which becomes a state prior to obtaining a polyimide film after completion of imidization by heating the coat which contains polyimide precursors and particles and is obtained in the first step to progress imidization.

Specifically, the coated film which has been obtained in the first step and from which particles are exposed is heated, and the particles are removed from the coat in the process of imidizing polyimide precursors (hereinafter, the coat in this state is sometimes referred to as a “polyimide film”). Alternatively, particles may be removed from the polyimide film after the imidization is completed. A porous polyimide film from which particles are removed is obtained (refer to FIG. 1).

In the process of removing particles, in a case where the particles are, for example, resin particles, resin components are sometimes contained in a porous polyimide film as resin components other than a polyimide resin. Although not shown in the drawing, the porous polyimide film may contain components (for example, resin components) other than the polyimide resin.

For example, the processing of removing particles is preferably performed when the imidization ratio of polyimide precursors in a polyimide film is greater than or equal to 10% in the process of imidizing the polyimide precursor from the viewpoint of removability of particles and the like. In a case where the imidization ratio is greater than or equal to 10%, particles are hardly dissolved in an organic solvent, and the form is easily maintained.

The processing of removing particles is not particularly limited. Examples thereof include a method for decomposing and removing particles by heating the particles, a method for removing particles using an organic solvent that dissolves the particles, and a method for removing particles by decomposing the particles with a laser or the like.

The removal of particles may be performed, for example, by only decomposition and removal of particles using heat which also serves as the imidization step, or by decomposition and removal of particles using heat and removal of particles using an organic solvent that dissolves particles in combination. From the viewpoints of more easily relaxing residual stress and suppressing generation of cracks in a porous polyimide film, for example, a method including processing of removing particles using an organic solvent that dissolves the particles is preferable. Itis assumed that this action is taken in order to easily transfer components dissolved in the organic solvent into a polyimide resin in the processing of removing particles using an organic solvent.

For example, in the method for removing particles using heat, decomposition gas due to heating is sometimes generated depending on the types of particles. Due to the decomposition gas, breakage or cracks sometimes occur in a porous polyimide film. For this reason, for example, it is preferable to employ the method for removing particles using an organic solvent that dissolves the particles from the viewpoint of suppressing the generation of cracks.

It is also effective to increase the removal rate by removing particles using an organic solvent that dissolves the particles and subsequently performing heating.

In addition, in a case of removing particles through the method for removing particles using an organic solvent that dissolves the particles, components of particles dissolved in the organic solvent infiltrate into a polyimide film in the process of the removal of particles. For example, it is preferable to employ the method for removing particles using an organic solvent that dissolves the particles also from the viewpoint of containing components other than the polyimide resin. For example, it is more preferable to perform the removal of particles through this method on a coat in the process of imidizing polyimide precursors from the viewpoint of containing a resin other than the polyimide resin. In some cases, the components are easily infiltrated into a polyimide film by dissolving particles using a solvent that dissolves the particles in the state of the coat in the process of imidization.

An example of the method for removing particles using an organic solvent that dissolves the particles includes a method for removing particles by bringing the particles into contact with the organic solvent in which the particles are dissolved (for example, by immersing particles in a solvent or bringing particles into contact with solvent vapor) to dissolve the particles. At this time, for example, it is preferable to immerse the particles in a solvent from the viewpoint of improving the dissolution efficiency.

The organic solvent that dissolves resin particles for removing the particles is not particularly limited as long as it is an organic solvent in which particles can be dissolved and which does not dissolve a polyimide film and a polyimide film in which imidization is completed. In a case where the particles are resin particles, examples thereof include ethers such as tetrahydrofuran, 1,4-dioxane; aromatics such as benzene and toluene; ketones such as acetone; and esters such as ethyl acetate.

Among these, for example, ethers such as tetrahydrofuran and 1,4-dioxane and aromatics such as benzene and toluene are preferable, and tetrahydrofuran and toluene are more preferable.

In a case where an aqueous solvent remains during dissolution of resin particles, it is sometimes difficult to control the hole diameter since the aqueous solvent is dissolved in a solvent that dissolves non-crosslinked resin particles and polyimide precursors are precipitated, which is in a state similar to the state of a so-called wet phase conversion method. Therefore, for example, it is preferable to decompose and remove the non-crosslinked resin particles using an organic solvent after reducing the amount of the remaining aqueous solvent to be less than or equal to 20 mass % and preferably less than or equal to 10 mass % based on the mass of polyimide precursors.

In the third step, the heating method for obtaining a polyimide film by heating the coat obtained in the second step to progress imidization is not particularly limited. An example thereof includes a method for performing heating in two or more multiple stages. In a case where the particles are resin particles and the heating is performed in two stages, specific examples of heating conditions are as below.

As the heating condition in the first stage, for example, a temperature at which the shape of resin particles is maintained is desirable. Specifically, for example, the temperature may be within a range of 50° C. to 150° C. and is, preferably within a range of 60° C. to 140° C. In addition, for example, the heating time may be within a range of 10 minutes to 60 minutes.

The higher the heating time is, the shorter the heating time may be.

As an example of the heating condition in the second stage, heating is performed under the conditions, for example, at 150° C. to 450° C. (for example, preferably 200° C. to 400° C.) for 20 minutes to 120 minutes. By setting the heating conditions within this range, the imidization reaction can further be progressed to form a polyimide film. During the heating reaction, for example, heating may be performed so that the temperature may be increased stepwisely or gradually at a constant rate before the temperature reaches a final temperature of heating.

The heating conditions are not limited to the above-described two-stage heating method, and the one-stage heating method may be employed, for example. In the case of the one-stage heating method, imidization may be completed only under the heating conditions shown in the above-described second stage.

In a case where processing of exposing particles is not performed in the first step, the particles may be exposed through processing of exposing particles in the second step from the viewpoint of improving the aperture ratio. In the second step, for example, the processing of exposing particles is preferably performed in the process of or after imidizing polyimide precursors and prior to processing of removing resin particles.

An example of the processing of exposing particles includes processing performed when a polyimide film is in a state shown below.

In a case of performing the processing of exposing particles when the imidization ratio of polyimide precursors in the polyimide film is less than 10% (that is, the polyimide film is in a state in which it can be dissolved in water), examples of the processing of exposing particles buried in the above-described polyimide film include wiping processing and processing of immersing particles in water.

In addition, in a case of performing processing of exposing resin particles when the imidization ratio of polyimide precursors in a polyimide film is greater than or equal to 10% (that is, in a state in which particles are dissolved in an organic solvent) and when a polyimide film is in a state in which imidization is completed, examples of the method include a method for exposing particles by mechanically cutting the polyimide film with tools such as sandpaper, a method for etching the polyimide film with an alkaline solution or the like in which a polyimide resin is dissolved, and a method for exposing particles by decomposing the polyimide film with a laser or the like.

In the case of mechanically cutting the polyimide film, some particles present in an upper region (that is, a region on a side away from a substrate of a particle layer) of the particle layer buried in the polyimide film are cut together with the polyimide film present in the upper portion of the resin particles, and the cut particles are exposed from the surface of the polyimide film.

Thereafter, the particles are removed through the previously described processing of removing particles, from the polyimide film from which the particles are exposed. A porous polyimide film from which the particles are removed is obtained.

In a case of forming a coat on a substrate using a polyimide precursor solution, the top of the substrate is coated with the polyimide precursor solution to form a coated film in which particles are buried. In a case of forming a coat containing polyimide precursors and particles without performing the processing of exposing particles in the process of forming a coat by drying the coated film, in some cases, a coat in which particles are buried is formed. In a case where the particles are, for example, resin particles, in a case where a coat in which the resin particles are buried is heated, a coat in the process of imidization enters a state where a resin particle layer is buried. In order to improve the aperture ratio, the same processing as the above-described processing of exposing particles can be employed as processing of exposing resin particles to be performed in the second step.

The resin particles are cut together with the polyimide film present in the upper portion of the resin particles and are exposed from the surface of the polyimide film.

Thereafter, the resin particles are removed through the previously described processing of removing particles, from the polyimide film from which the resin particles are exposed. A porous polyimide film from which the resin particles are removed is obtained.

In the third step, the substrate which has been used for forming the above-described coat in the second step may be peeled off when the coat is dried, when polyimide precursors in the polyimide film are hardly dissolved in an organic solvent, or when a film in which imidization is completed is obtained.

Here, the imidization ratio of polyimide precursors will be described.

Examples of polyimide precursors some of which are imidized include precursors with structures having repeating units represented by General Formulae (I-1), (I-2), and (I-3).

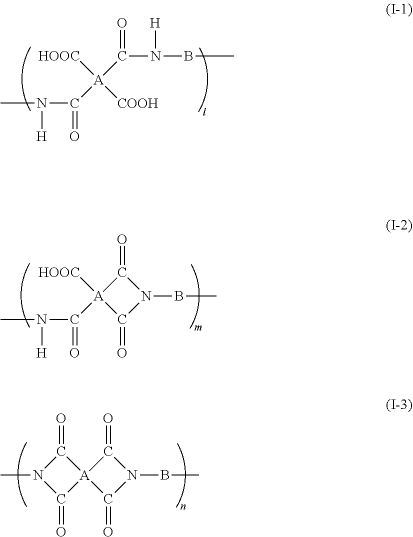

In General Formulae (I-1), (I-2), and (I-3), A represents a tetravalent organic group, and B represents a divalent organic group. l represents an integer of 1 or more, and m and n each independently represent 0 or an integer of 1 or more.

A and B have the same meaning as A and B in General Formula (I) to be described below.

The imidization ratio of polyimide precursors represents a ratio of the number (2n+m) of bonding portions subjected to imide-ring closure to the total number (2l+2m+2n) of bonding portions in the bonding portions of polyimide precursors (reaction portions of tetracarboxylic acid dianhydride and diamine compounds). That is, the imidization ratio of polyimide precursors is represented by “(2n+m)/(2l+2m+2n)”.

The imidization ratio (a value of “(2n+m)/(2l+2m+2n)”) of polyimide precursors is measured through the following method.

Measurement of Imidization Ratio of Polyimide Precursors

Production of Polyimide Precursor Sample

(i) The top of a silicon wafer is coated with a polyimide precursor solution to be measured within a film thickness range of 1 μm to 10 μm to produce a coated film sample.

(ii) The coated film sample is immersed in tetrahydrofuran (THF) for 20 minutes to replace a solvent in the coated film sample with tetrahydrofuran (THF). The solvent to be immersed is not limited to THF, and can be selected from solvents which do not dissolve polyimide precursors and can be mixed with solvent components contained in the polyimide precursor solution. Specifically, alcohol solvents such as methanol and ethanol and ether compounds such as dioxane can be used.

(iii) The coated film sample is taken out from THF, N₂ gas is blown to THF adhered to the surface of the coated film sample to remove THF. The coated film sample is dried for 12 hours or longer under a reduced pressure of lower than or equal to 10 mmHg within a temperature range of 5° C. to 25° C. to produce a polyimide precursor sample.

Production of 100% Imidized Standard Sample

(iv) The top of a silicon wafer is coated with a polyimide precursor solution to be measured in the same manner as in the above-described (i) to produce a coated film sample.

(v) An imidization reaction is caused by heating the coated film sample for 60 minutes at 380° C. to produce a 100% imidization standard sample.

Measurement and Analysis

(vi) Infrared absorption spectra of the 100% imidized standard sample and the polyimide precursor sample are measured using a Fourier transform infrared spectrophotometer (manufactured by HORIBA, Ltd., FT-730). A ratio I′ (100) of an absorption peak (Ab′ (1,780 cm⁻¹)) derived from an imide bond in the vicinity of 1,780 cm⁻¹ to an absorption peak (Ab′ (1,500 cm⁻¹)) derived from an aromatic ring in the vicinity of 1, 500 cm⁻¹ of the 100% imidized standard sample is obtained.

(vii) Similarly, a ratio I (x) of an absorption peak (Ab (1, 780 cm⁻¹)) derived from an imide bond in the vicinity of 1,780 cm⁻¹ to an absorption peak (Ab(1,500 cm⁻¹)) derived from an aromatic ring in the vicinity of 1, 500 cm⁻¹ is obtained by performing measurement on the polyimide precursor sample.

The imidization ratio of the polyimide precursors is calculated based on the following equation using each of the measured absorption peaks I′ (100) and I (x).

Imidization ratio of polyimide precursors=I(x)/I′(100) Equation:

I′(100)=(Ab′(1,780 cm⁻¹))/Ab′(1,500 cm⁻¹)) Equation:

I(x)=(Ab(1,780 cm⁻¹))/(Ab(1,500 cm⁻¹)) Equation:

The measurement of the imidization ratio of the polyimide precursors is applied to measurement of the imidization ratio of aromatic polyimide precursors. In a case of measuring the imidization ratio of aliphatic polyimide precursors, a peak derived from a structure that does not change before and after the imidization reaction is used as an internal standard peak instead of the absorption peak of an aromatic ring.

Method for Producing Separator for Lithium Ion Secondary Battery

The method for producing a separator for a lithium ion secondary battery according to the present exemplary embodiment includes: a step of heating the coat produced by the previously described production method and imidizing the polyimide precursors contained in the coat to form a polyimide film; and a step of removing the particles.

The step of heating the coat and imidizing the polyimide precursors contained in the coat to form a polyimide film and the step of removing the particles are the same steps as the previously described third step.

Hereinafter, an example of a method for producing a separator for a lithium ion secondary battery according to the present exemplary embodiment will be described.

The separator for a lithium ion secondary battery obtained through the method for producing a separator for a lithium ion secondary battery according to the present exemplary embodiment contains a porous polyimide film.

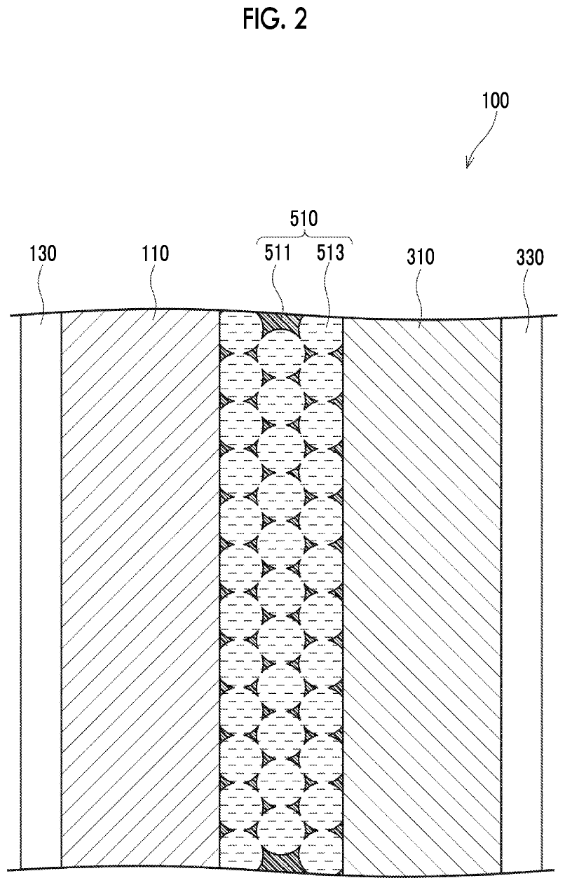

Hereinafter, the lithium ion secondary battery of the present exemplary embodiment will be described with reference to FIG. 2.

FIG. 2 is a partial cross-sectional schematic diagram showing an example of a lithium ion secondary battery to which a separator for a lithium ion secondary battery according to the present exemplary embodiment is applied. As shown in FIG. 2, a lithium ion secondary battery 100 includes a positive electrode active material layer 110, a separator layer 510, and a negative electrode active material layer 310 which are accommodated in an exterior member not shown in the drawing. The positive electrode active material layer 110 is provided on a positive electrode current collector 130, and the negative electrode active material layer 310 is provided on a negative electrode current collector 330. The separator layer 510 is provided so as to separate the positive electrode active material layer 110 from the negative electrode active material layer 310 and is disposed between the positive electrode active material layer 110 and the negative electrode active material layer 310 so that the positive electrode active material layer 110 and the negative electrode active material layer 310 are opposed to each other. The separator layer 510 includes a separator 511 and an electrolyte 513 with which holes of the separator 511 is filled. A porous polyimide film obtained through the method for producing a separator for a lithium ion secondary battery according to the present exemplary embodiment is applied to the separator 511. The positive electrode current collector 130 and the negative electrode current collector 330 are members provided as necessary.

Positive Electrode Current Collector 130 and Negative Electrode Current Collector 330

The material used for the positive electrode current collector 130 and the negative electrode current collector 330 is not particularly limited and may be a well-known conductive material. For example, metal such as aluminum, copper, nickel, and titanium can be used.

Positive Electrode Active Material Layer 110

The positive electrode active material layer 110 is a layer containing a positive electrode active material.

Well-known additives such as a conductive assistant and a binder resin may be contained therein as necessary. The positive electrode active material is not particularly limited, and a well-known positive electrode active material can be used. Examples thereof include composite oxides (LiCoO₂, LiNiO₂, LiMnO₂, LiMn₂O₄, LiFeMnO₄, and LiV₂O₅), phosphates (LiFePO₄, LiCoPO₄, LiMnPO₄, and LiNiPO₄) containing lithium, and conductive polymers (polyacetylene, polyaniline, polypyrrole, and polythiophene). The positive electrode active materials may be used alone or in combination of two or more thereof.

Negative Electrode Active Material Layer 310

The negative electrode active material layer 310 is a layer containing a negative electrode active material. Well-known additives such as a binder resin may be contained therein as necessary. The negative electrode active material is not particularly limited, and a well-known positive electrode active material can be used. Examples thereof include carbon materials (such as graphite (natural graphite and artificial graphite), carbon nanotubes, graphitized carbon, and low-temperature calcined carbon), metal (such as aluminum, silicon, zirconium, and titanium), and metal oxides (such as tin dioxide and lithium titanate). The negative electrode active materials may be used alone or in combination of two or more thereof.

Electrolyte 513

Examples of the electrolyte 513 include an electrolyte and a non-aqueous electrolyte solution containing non-aqueous solvent.

Examples of electrolytes include lithium salt electrolytes (such as LiPF₆, LiBF₄, LiSbF₆, LiAsF₆, LiClO₄, LiN(FSO₂)₂, LiN(CF₃SO₂)₂, LiN(C₂F₅SO₂), and LiC(CF₃SO₂)₃). The electrolytes may be used alone or in combination of two or more thereof.

Examples of non-aqueous solvents include cyclic carbonates (ethylene carbonate, propylene carbonate, and butylene carbonate), chain carbonates (diethyl carbonate, dimethyl carbonate, ethyl methyl carbonate, methyl acetate, ethyl acetate, methyl propionate, ethyl propionate, γ-butyrolactone, 1,2-dimethoxyethane, and 1,2-diethoxyethane. The non-aqueous solvents may be used alone or in a combination of two or more thereof.

Method for Producing Lithium Ion Secondary Battery 100

An example of a method for producing the lithium ion secondary battery 100 will be described.

The positive electrode current collector 130 is coated with a coating solution for forming the positive electrode active material layer 110 containing a positive electrode active material and dried to obtain a positive electrode including the positive electrode active material layer 110 provided on the positive electrode current collector 130.

Similarly, the negative electrode current collector 330 is coated with a coating solution for forming the negative electrode active material layer 310 containing a negative electrode active material and dried to obtain a negative electrode including the negative electrode active material layer 310 provided on the negative electrode current collector 330. The positive electrode and the negative electrode may be subjected to compression processing as necessary.

Next, the separator 511 is disposed between the positive electrode active material layer 110 and the negative electrode active material layer 310 of a negative electrode so that the positive electrode active material layer 110 of a positive electrode and the negative electrode active material layer 310 of the negative electrode are opposed to each other. In the stacked body structure, the positive electrodes (the positive electrode current collector 130 and the positive electrode active material layer 110), the separator layer 510, and the negative electrodes (the negative electrode active material layer 310 and the negative electrode current collector 330) are stacked in this order. At this time, compression processing may be performed as necessary.

Next, the stacked structure is accommodated in the exterior member, and then, the electrolyte 513 is injected into the stacked structure. The injected electrolyte 513 penetrates into holes of the separator 511.

In this manner, the lithium ion secondary battery 100 is obtained.

As described above, the lithium ion secondary battery to which the separator for a lithium ion secondary battery of the present exemplary embodiment is applied has been described with reference to FIG. 2, but the lithium ion secondary battery of the present exemplary embodiment is not limited thereto. The form is not particularly limited as long as a porous polyimide film as an example of the polyimide film according to the present exemplary embodiment is applied thereto.

All-Solid Battery

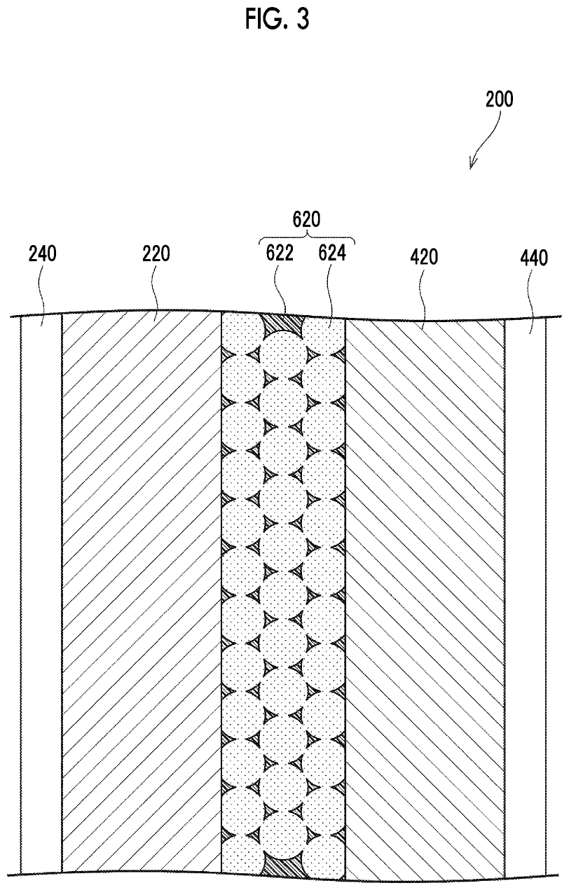

Next, an all-solid battery to which the polyimide film of the present exemplary embodiment is applied will be described. Hereinafter, the all-solid battery will be described with reference to FIG. 3.

FIG. 3 is a partial cross-sectional schematic diagram showing an example of the all-solid battery according to the present exemplary embodiment. As shown in FIG. 3, an all-solid battery 200 includes a positive electrode active material layer 220, a solid electrolyte layer 620, and a negative electrode active material layer 420 which are accommodated in an exterior member not shown in the drawing. The positive electrode active material layer 220 is provided on a positive electrode current collector 240, and the negative electrode active material layer 420 is provided on a negative electrode current collector 440. The solid electrolyte layer 620 is disposed between the positive electrode active material layer 220 and the negative electrode active material layer 420 so that the positive electrode active material layer 220 and the negative electrode active material layer 420 are opposed to each other. The solid electrolyte layer 620 includes a solid electrolyte 624 and a support 622 that holds the solid electrolyte 624, and holes of the support 622 are filled with the solid electrolyte 624. The polyimide film according to the present exemplary embodiment is applied to the support 622 that holds the solid electrolyte 624. The positive electrode current collector 240 and the negative electrode current collector 440 are members provided as necessary.

Positive Electrode Current Collector 240 and Negative Electrode Current Collector 440

Examples of materials used for the positive electrode current collector 240 and the negative electrode current collector 440 include the same materials as the materials described for the above-described lithium ion secondary battery.

Positive Electrode Active Material Layer 220 and Negative Electrode Active Material Layer 420

Examples of materials used for the positive electrode active material layer 220 and the negative electrode active material layer 420 include the same materials as the materials described for the above-described lithium ion secondary battery.

Solid Electrolyte 624

The solid electrolyte 624 is not particularly limited, and examples thereof include well-known solid electrolytes. Examples thereof include a polymer solid electrolyte, an oxide solid electrolyte, a sulfide solid electrolyte, a halide solid electrolyte, and nitride solid electrolyte.

Examples of polymer solid electrolytes include fluororesins (homopolymers such as polyvinylidene fluoride, polyhexafluoropropylene, and polytetrafluoroethylene, and copolymers having the fluororesins as constitutional units), a polyethylene oxide resin, a polyacrylonitrile resin, and a polyacrylate resin. For example, a sulfide solid electrolyte is preferably contained from the viewpoint of excellent lithium ion conductivity. For example, a sulfide solid electrolyte containing sulfur and at least one of lithium or phosphorus as constituent elements is preferably contained in the same respect.

An example of an oxide solid electrolyte includes oxide solid electrolyte particles containing lithium. Examples thereof include Li₂O—B₂O₃—P₂O₅ and Li₂O—SiO₂.

Another example of a sulfide solid electrolyte includes a sulfide solid electrolyte containing sulfur and at least one of lithium or phosphorus as constituent elements. Examples thereof include 8Li₂O-67Li₂S-25P₂S₅, Li₂S, P₂S₅, Li₂S—SiS₂, LiI—Li₂S—SiS₂, LiI—Li₂S—P₂S₅, LiI—Li₃PO₄—P₂S₅, LiI—Li₂S—P₂O₅, and LiI—Li₂S—B₂S₃.

An example of a halide solid electrolyte includes LiI.

An example of a nitride solid electrolyte includes Li₃N.

Method for Producing All-Solid Battery 200

An example of a method for producing the all-solid battery 200 will be described.

The positive electrode current collector 240 is coated with a coating solution for forming the positive electrode active material layer 220 containing a positive electrode active material and dried to obtain a positive electrode including the positive electrode active material layer 220 provided on the positive electrode current collector 240.

Similarly, the negative electrode current collector 440 is coated with a coating solution for forming the negative electrode active material layer 420 containing a negative electrode active material and dried to obtain a negative electrode including the negative electrode active material layer 420 provided on the negative electrode current collector 440.

The positive electrode and the negative electrode may be subjected to compression processing as necessary.

Next, the top of a substrate is coated with a coating solution containing the solid electrolyte 624 for forming the solid electrolyte layer 620 and dried to form a layered solid electrolyte. Next, a polyimide film as the support 622 and the layered solid electrolyte 624 are superimposed on the positive electrode active material layer 220 of a positive electrode as a material for forming the solid electrolyte layer 620. A negative electrode is superimposed on the material for forming the solid electrolyte layer 620 so that the negative electrode active material layer 420 of the negative electrode is on the positive electrode active material layer 220 to form a stacked structure. In the stacked body structure, the positive electrodes (the positive electrode current collector 240 and the positive electrode active material layer 220), the solid electrolyte layer 620, and the negative electrodes (the negative electrode active material layer 420 and the negative electrode current collector 440) are stacked in this order.

Next, the stacked structure is subjected to compression processing, holes of the polyimide film as the support 622 is impregnated with the solid electrolyte 624 to support the solid electrolyte 624.

Next, the stacked structure is accommodated in the exterior member.

In this manner, the all-solid battery 200 is obtained.

As described above, the all-solid battery according to the present exemplary embodiment has been described with reference to FIG. 3, but the all-solid battery according to the present exemplary embodiment is not limited thereto. The form is not particularly limited as long as a porous polyimide film as an example of the polyimide film according to the present exemplary embodiment is applied thereto.

### EXAMPLES

Examples will be described below, but the present invention is not limited to the examples. In the following description, unless otherwise specified, the units “parts” and “%” are all on a mass basis.

Production of Particles

Preparation of Particle Dispersion (1)

A solution obtained by mixing 280 parts by mass of styrene, 120 parts by mass of n-butylacrylate, 6 parts by mass of acrylic acid, and 24 parts by mass of dodecanethiol with each other and dissolving the mixture is dispersed in a solution obtained by dissolving 10 parts by mass of DOWFAX2A1 (47% solution, manufactured by Dow Chemical Company) in 550 parts by mass of ion exchange water and emulsified in a flask. 50 g of ion exchange water in which 4 parts by mass of ammonium persulfate is dissolved is put into the emulsion while slowly mixing the emulsion for 10 minutes, and nitrogen substitution is performed. Thereafter, the resultant is heated in an oil bath until the contents reached 70° C. while stirring the contents in the flask, and emulsion and polymerization are continued as it is for 5 hours. Thereafter, the reaction solution is cooled at room temperature to prepare a particle dispersion (1) obtained by dispersing resin particles having an average particle diameter of 208 nm.

Production of Particles (1)

330 parts by mass of the particle dispersion (1), 1,260 parts by mass of ion exchange water, and 36 parts by mass of a 1.0% polyaluminum chloride solution are accommodated in a flask made of round stainless steel and dispersed with a homogenizer (ULTRA TURRAX T50 manufactured by IKA). Then, the resultant is heated to a temperature, at which a desired particle diameter can be obtained, in an oil bath for heating. A 1N aqueous sodium hydroxide solution is added to the aggregated particle dispersion to adjust the pH to 7.0. Thereafter, the temperature is raised to 98° C. while continuously stirring the mixture, which is then held until the circularity reached a desired level. In a case where the circularity reached a desired level, the mixture is rapidly cooled in an ice bath, filtered, and washed with water to obtain aggregated particles. As shown in Table 1, the average particle diameter of the particles (1) is 7 μm, the average circularity is 0.914, and the standard deviation of circularity distribution is 0.045.

Production of Polyester Resin (1)

133.2 parts by mass of dimethyl terephthalate, 59.1 parts by mass of dimethyl isophthalate, 26.0 parts by mass of ethylene glycol, 9.2 parts by mass of glycerin, and 172.2 parts by mass of a bisphenol A propylene oxide 2-mol adduct, are placed in a three-neck flask equipped with a stirrer and a distillation tube, and 0.1 parts by mass of calcium acetate and 0.1 parts by mass of antimony (III) oxide are placed therein as condensation catalysts. The temperature is raised while distilling off methanol and ethylene glycol produced in a nitrogen stream, and the mixture is stirred for 30 minutes while maintaining the temperature at 150° C. and further stirred for 1 hour while maintaining the temperature at 190° C.

Next, the temperature is lowered to 150° C., the pressure in a reaction system is gradually reduced using a pump, the temperature in the reaction system is raised while maintaining the pressure in the reaction system within a range of 10 Pa to 40 Pa, and the mixture is further reacted for 3 hours at 250° C. and is taken out. The acid value of the taken out polyester resin (1) is 10.2 mgKOH/g.

Adjustment of Particle Dispersion (8)

500 parts by mass of the synthesized polyester resin (1) are added to a flask, 400 parts by mass of methyl ethyl ketone (MEK) are further added thereto, and the mixture is stirred. An amount of 10% aqueous solution of sodium hydroxide for neutralizing 0.8 equivalent of the total amount of carboxylic acid contained in the polyester resin (1) is added thereto while stirring the mixture. 1,200 parts by mass of water are gradually added to this solution while continuing the stirring, and phase inversion emulsification is performed.

Next, a distillation tube and a decompression pump are attached to the flask, the solution is heated so as to become 30° C. to 35° C., the pressure is reduced while performing stirring, and the solution is concentrated while distilling off methyl ethyl ketone to obtain a particle dispersion (8) having a particle diameter of 198 nm.

Production of Particles (8)

330 parts by mass of the particle dispersion (8), 1,260 parts by mass of ion exchange water, and 36 parts by mass of a 1.0% polyaluminum chloride solution are accommodated in a flask made of round stainless steel and dispersed with a homogenizer (ULTRA TURRAX T50 manufactured by IKA). Then, the resultant is heated to a temperature, at which a desired particle diameter can be obtained, in an oil bath for heating. A 1N aqueous sodium hydroxide solution is added to the aggregated particle dispersion to adjust the pH to 7.0. Thereafter, the temperature is raised to 98° C. while continuously stirring the mixture, which is then held until the circularity reached a desired level. In a case where the circularity reached a desired level, the mixture is rapidly cooled in an ice bath, filtered, and washed with water to obtain aggregated particles. As shown in Table 1, the average particle diameter of the particles (8) is 19 μm, the average circularity is 0.911, and the standard deviation of circularity distribution is 0.052.

Production of Particles (2) to (7) and (C1) to (C9)

The components are mixed with each other similarly to the case of the particles (1), and conditions for mixing, stirring, emulsification, and polymerization are adjusted to obtain each of particles having values shown in Table 1.

Production of Particles (9)

The components are mixed with each other similarly to the case of the particles (8), and conditions for mixing, stirring, emulsification, and polymerization are adjusted to obtain particles having values shown in Table 1.

TABLE 1

| | | | Average | | Standard |
|---|---|---|---|---|---|
| Particle | | | particle | | deviation of |
| dispersion | | | diameter | Average | circularity |
| No. | Particle name | Type | (μm) | circularity | distribution |
| (1) | Particle (1) | Styrene/butyl acrylate/acrylic acid | 7 | 0.914 | 0.045 |
| (2) | Particle (2) | Styrene/butyl acrylate/acrylic acid | 14 | 0.916 | 0.028 |
| (3) | Particle (3) | Styrene/butyl acrylate/acrylic acid | 28 | 0.919 | 0.036 |
| (4) | Particle (4) | Styrene/butyl acrylate/acrylic acid | 13 | 0.951 | 0.084 |
| (5) | Particle (5) | Styrene/butyl acrylate/acrylic acid | 6 | 0.979 | 0.039 |
| (6) | Particle (6) | Styrene/butyl acrylate/acrylic acid | 17 | 0.986 | 0.056 |
| (7) | Particle (7) | Styrene/butyl acrylate/acrylic acid | 26 | 0.982 | 0.051 |
| (8) | Particle (8) | Polyester | 19 | 0.911 | 0.052 |
| (9) | Particle (9) | Polyester | 9 | 0.920 | 0.032 |
| (C1) | Particle (C1) | Styrene/butyl acrylate/acrylic acid | 6 | 0.890 | 0.072 |
| (C2) | Particle (C2) | Styrene/butyl acrylate/acrylic acid | 13 | 0.887 | 0.055 |
| (C3) | Particle (C3) | Styrene/butyl acrylate/acrylic acid | 28 | 0.886 | 0.075 |
| (C4) | Particle (C4) | Styrene/butyl acrylate/acrylic acid | 9 | 0.997 | 0.062 |
| (C5) | Particle (C5) | Styrene/butyl acrylate/acrylic acid | 16 | 0.995 | 0.037 |
| (C6) | Particle (C6) | Styrene/butyl acrylate/acrylic acid | 29 | 0.997 | 0.082 |
| (C7) | Particle (C7) | Styrene/butyl acrylate/acrylic acid | 2.1 | 0.937 | 0.036 |
| (C8) | Particle (C8) | Styrene/butyl acrylate/acrylic acid | 39 | 0.922 | 0.059 |
| (C9) | Particle (C9) | Styrene/butyl acrylate/acrylic acid | 15 | 0.942 | 0.142 |

Production of Polyimide Precursor Solution

Production of Polyimide Precursor Solution (A-1)

560.0 parts by mass of ion exchange water is heated to 50° C. in a nitrogen stream, and 53.75 parts by mass of p-phenylenediamine (hereinafter, also referred to as “PDA”) and 146.25 parts by mass of 3,3′,4,4′-biphenyltetracarboxylic acid dianhydride (hereinafter, also referred to as “BPDA”) are added thereto while performing stirring. A mixture of 150.84 parts by mass of N-methylmorpholine (hereinafter, also referred to as “MMO”) and 89.16 parts by mass of ion exchange water is added thereto over 20 minutes while performing stirring at 50° C. in a nitrogen stream. The mixture is reacted for 15 hours at 50° C. to obtain a polyimide precursor solution (A-1) having a solid content concentration of 20 mass %.

Production of Polyimide Precursor Solution (A-2)

A polyimide precursor solution (A-2) having a solid content concentration of 20 mass % is obtained similarly to the polyimide precursor solution (A-1) except that N-methylmorpholine in the production of the polyimide precursor solution (A-1) is changed to 1,2-dimethylimidazole.

Production of Polyimide Precursor Solution (A-3)

A polyimide precursor solution (A-3) having a solid content concentration of 20 mass % is obtained similarly to the polyimide precursor solution (A-1) except that N-methylmorpholine in the production of the polyimide precursor solution (A-1) is changed to N,N-dimethyl-2-aminoethanol.

### Example 1

Polyimide precursors, particles, and a water-soluble organic solvent are mixed with each other so as to have a composition shown in Table 2. The mixing is performed by ultrasonically dispersing the mixture for 30 minutes at 50° C. to obtain a polyimide precursor solution. In addition, an evaluation shown below is performed using the obtained polyimide precursor solution. The results are shown in Table 2.

Evaluation

(1) Evaluation of Cracks

An aluminum plate for forming a coated film of a polyimide precursor solution obtained in each example is prepared. The surface of the aluminum plate is coated with a solution obtained by dissolving a releasing agent KS-700 (manufactured by Shin-Etsu Chemical Co., Ltd.) in toluene so as to obtain a thickness of about 0.05 μm after drying, and a release layer subjected to a heat treatment at 400° C. is provided thereon.

Next, the top of the release layer of the aluminum substrate is coated with the polyimide precursor solution so that the film thickness after drying becomes 30 μm to form a coated film. The coated film is heated and dried for 1 hour at 90° C. to form a coat containing polyimide precursors and particles. The presence or absence of cracks in the 1 cm² square area of the obtained coat is visually observed with a microscope of 500 magnifications while regarding a range of greater than or equal to 0.1 mm as a crack, and an evaluation is performed according to the following evaluation criteria. The results are shown in Table 2.

Evaluation Criteria

A: No cracks

B: 1 to 3 cracks

C: 4 or more cracks

(2) Evaluation of Tensile Strength

An aluminum plate for forming a coated film of a polyimide precursor solution obtained in each example is prepared. The surface of the aluminum plate is coated with a solution obtained by dissolving a releasing agent KS-700 (manufactured by Shin-Etsu Chemical Co., Ltd.) in toluene so as to obtain a thickness of about 0.05 μm after drying, and a release layer subjected to a heat treatment at 400° C. is provided thereon.

Next, the top of the release layer of the aluminum substrate is coated with the polyimide precursor solution so that the film thickness after drying becomes 30 μm to form a coated film. The coated film is heated and dried for 1 hour at 90° C. Thereafter, the temperature is raised from room temperature (25° C., hereinafter, the same applies) to 380° C. at a rate of 10° C./minute and is held at 380° C. for 1 hour. Then, the temperature is cooled to room temperature to obtain a porous polyimide film having a film thickness of about 30 μm. 5 mm×100 mm samples prepared from the obtained porous polyimide film are prepared, the tensile strength of the porous polyimide films is measured under the condition of a distance 60 mm between chucks using a tensile tester (STROGRAPH VI-C manufactured by Toyo Seiki Seisaku-sho, Ltd.), and an evaluation is performed according to the following criteria. The results are shown in Table 2.

A: Larger than or equal to 20 N/mm²

B: Larger than or equal to 10 N/mm² and less than 20 N/mm²

C: Less than 10 N/mm²

### Examples 2 to 12 and Comparative Examples 1 to 9

Polyimide precursor solutions are obtained through the same method as in Example 1 except that polyimide precursors, particles, and a water-soluble organic solvent are mixed with each other so as to have a composition shown in Table 2. In addition, the same evaluation as in Example 1 is performed. The results are shown in Table 2.

TABLE 2

| | | | Example | Example | Example | Example | Example | Example | Example | Example |
|---|---|---|---|---|---|---|---|---|---|---|
| | | | 1 | 2 | 3 | 4 | 5 | 6 | 7 | 8 |
| Particle | | Type | Particle | Particle | Particle | Particle | Particle | Particle | Particle | Particle |
| | | | (1) | (2) | (3) | (4) | (5) | (6) | (7) | (8) |
| | | Amount of | 12.5 | 12.5 | 12.5 | 12.5 | 12.5 | 12.5 | 12.5 | 12.5 |
| | | solid | | | | | | | | |
| | | content | | | | | | | | |
| | | (mass %) | | | | | | | | |
| Polyimide precursor | | Polyimide | A-1 | A-1 | A-1 | A-1 | A-1 | A-1 | A-1 | A-1 |
| | | precursor | | | | | | | | |
| | | solution | | | | | | | | |
| | | Amount of | 7.5 | 7.5 | 7.5 | 7.5 | 7.5 | 7.5 | 7.5 | 7.5 |
| | | solid | | | | | | | | |
| | | content | | | | | | | | |
| | | (mass %) | | | | | | | | |
| aqueous | Water-soluble | Type | NMP | NMP | NMP | NMP | NMP | NMP | NMP | NMP |
| solvent | organic | Amount | 5.25 | 5.25 | 5.25 | 5.25 | 5.25 | 5.25 | 5.25 | 5.25 |
| | solvent | (mass %) | | | | | | | | |
| | Organic | Type | MMO | MMO | MMO | MMO | MMO | MMO | MMO | MMO |
| | amine | Amount | 5.66 | 5.66 | 5.66 | 5.66 | 5.66 | 5.66 | 5.66 | 5.66 |
| | compound | (mass %) | | | | | | | | |
| | Water | Amount | 69.09 | 69.09 | 69.09 | 69.09 | 69.09 | 69.09 | 69.09 | 69.09 |
| | | (mass %) | | | | | | | | |

| | | | | | | | | |
|---|---|---|---|---|---|---|---|---|
| Ratio (mass %) of water to aqueous | 86% | 86% | 86% | 86% | 86% | 86% | 86% | 86% |
| solution | | | | | | | | |
| Volume ratio (%) of particles to total | 70% | 70% | 70% | 70% | 70% | 70% | 70% | 70% |
| volume of solid content of polyimide | | | | | | | | |
| precursors and particles | | | | | | | | |
| Evaluation of cracks of coat | A | A | A | A | A | A | A | A |
| Tensile strength of polyimide film | A | A | A | A | A | A | A | A |

| | | | | | | | Comparative | Comparative | Comparative |
|---|---|---|---|---|---|---|---|---|---|
| | | | Example | Example | Example | Example | Example | Example | Example |
| | | | 9 | 10 | 11 | 12 | 1 | 2 | 3 |
| Particle | | Type | Particle | Particle | Particle | Particle | Particle | Particle | Particle |
| | | | (9) | (1) | (1) | (1) | (C1) | (C2) | (C3) |
| | | Amount of | 12.5 | 12.5 | 12.5 | 12.5 | 12.5 | 12.5 | 12.5 |
| | | solid | | | | | | | |
| | | content | | | | | | | |
| | | (mass %) | | | | | | | |
| Polyimide precursor | | Polyimide | A-1 | A-1 | A-2 | A-3 | A-1 | A-1 | A-1 |
| | | precursor | | | | | | | |
| | | solution | | | | | | | |
| | | Amount of | 7.5 | 7.5 | 7.5 | 7.5 | 7.5 | 7.5 | 7.5 |
| | | solid | | | | | | | |
| | | content | | | | | | | |
| | | (mass %) | | | | | | | |
| aqueous | Water-soluble | Type | NMP | DMAc | NMP | NMP | NMP | NMP | NMP |
| solvent | organic | Amount | 5.25 | 5.25 | 5.25 | 5.25 | 5.25 | 5.25 | 5.25 |
| | solvent | (mass %) | | | | | | | |
| | Organic | Type | MMO | MMO | DMZ | DMAE | MMO | MMO | MMO |
| | amine | Amount | 5.66 | 5.66 | 5.66 | 5.66 | 5.66 | 5.66 | 5.66 |
| | compound | (mass %) | | | | | | | |
| | Water | Amount | 69.09 | 69.09 | 69.09 | 69.09 | 69.09 | 69.09 | 69.09 |
| | | (mass %) | | | | | | | |

| | | | | | | | |
|---|---|---|---|---|---|---|---|
| Ratio (mass %) of water to aqueous | 86% | 86% | 86% | 86% | 86% | 86% | 86% |
| solution | | | | | | | |
| Volume ratio (%) of particles to total | 70% | 70% | 70% | 70% | 70% | 70% | 70% |
| volume of solid content of polyimide | | | | | | | |
| precursors and particles | | | | | | | |
| Evaluation of cracks of coat | A | A | A | A | B | C | C |
| Tensile strength of polyimide film | A | A | A | B | C | C | C |

| | | | Comparative | Comparative | Comparative | Comparative | Comparative | Comparative |
|---|---|---|---|---|---|---|---|---|
| | | | Example | Example | Example | Example | Example | Example |
| | | | 4 | 5 | 6 | 7 | 8 | 9 |
| Particle | | Type | Particle | Particle | Particle | Particle | Particle | Particle |
| | | | (C4) | (C5) | (C6) | (C7) | (C8) | (C9) |
| | | Amount of | 12.5 | 12.5 | 12.5 | 12.5 | 12.5 | 12.5 |
| | | solid | | | | | | |
| | | content | | | | | | |
| | | (mass %) | | | | | | |
| Polyimide precursor | | Polyimide | A-1 | A-1 | A-1 | A-1 | A-1 | A-1 |
| | | precursor | | | | | | |
| | | solution | | | | | | |
| | | Amount of | 7.5 | 7.5 | 7.5 | 7.5 | 7.5 | 7.5 |
| | | solid | | | | | | |
| | | content | | | | | | |
| | | (mass %) | | | | | | |
| aqueous | Water-soluble | Type | NMP | NMP | NMP | NMP | NMP | NMP |
| solvent | organic | Amount | 5.25 | 5.25 | 5.25 | 5.25 | 5.25 | 5.25 |
| | solvent | (mass %) | | | | | | |
| | Organic | Type | MMO | MMO | MMO | MMO | MMO | MMO |
| | amine | Amount | 5.66 | 5.66 | 5.66 | 5.66 | 5.66 | 5.66 |
| | compound | (mass %) | | | | | | |
| | Water | Amount | 69.09 | 69.09 | 69.09 | 69.09 | 69.09 | 69.09 |
| | | (mass %) | | | | | | |

| | | | | | | |
|---|---|---|---|---|---|---|
| Ratio (mass %) of water to aqueous | 86% | 86% | 86% | 86% | 86% | 86% |
| solution | | | | | | |
| Volume ratio (%) of particles to total | 70% | 70% | 70% | 70% | 70% | 70% |
| volume of solid content of polyimide | | | | | | |
| precursors and particles | | | | | | |
| Evaluation of cracks of coat | B | C | C | B | B | B |
| Tensile strength of polyimide film | C | C | C | C | C | C |

It can be seen from the results shown in Table 2 that cracking is hardly caused in the coats (that is, the films before an imidization treatment) produced using the polyimide precursor solutions obtained in the examples compared to polyimide precursor solutions obtained in the comparative examples. Furthermore, it can be seen that the tensile strength of the polyimide films (that is, the films after an imidization treatment) produced using the polyimide precursor solutions obtained in the examples is high compared to that obtained in the comparative examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A polyimide precursor solution comprising:
a polyimide precursor;
an aqueous solvent containing a water-soluble organic solvent and water; and
particles,
wherein the particles have a volume average particle diameter within a range of 2.5 μm to 30 μm, an average circularity within a range of 0.900 to 0.990, and a standard deviation of circularity distribution of less than or equal to 0.1.

2. The polyimide precursor solution according to claim 1,
wherein a content of the water is within a range of 50 mass % to 90 mass % based on the aqueous solvent.

3. The polyimide precursor solution according to claim 1,
wherein the particles are within a range of 40 volume % to 80 volume % based on a total volume of a solid content of the polyimide precursor and the particles.

4. The polyimide precursor solution according to claim 3,
wherein the particles are within a range of 50 volume % to 80 volume %.

5. The polyimide precursor solution according to claim 1,
wherein the water-soluble organic solvent contains an organic amine compound.

6. The polyimide precursor solution according to claim 5,
wherein the organic amine compound is a compound selected from the group consisting of triethylamine, N-alkylpiperidine, 2-dimethylaminoethanol, and a tertiary cyclic amine compound.

7. The polyimide precursor solution according to claim 6,
wherein the tertiary cyclic amine compound is a morpholine compound.

8. The polyimide precursor solution according to claim 7,
wherein the morpholine compound is N-methylmorpholine.

9. The polyimide precursor solution according to claim 1,
wherein the particles are resin particles.

10. The polyimide precursor solution according to claim 9,
wherein the resin particles are selected from the group consisting of styrene resin particles, (meth)acrylic resin particles, and polyester resin particles.

11. The polyimide precursor solution according to claim 1,
wherein the standard deviation of the circularity distribution is less than or equal to 0.07.

12. A method for producing a polyimide resin film, comprising:
coating a top of a substrate with the polyimide precursor solution according to claim 1 to form a coated film; and
drying the coated film to form a coat containing the polyimide precursor and the particles.

13. The method for producing a polyimide resin film according to claim 12, further comprising:
heating the coat produced by the method for producing a resin film according to claim 12 and imidizing the polyimide precursor contained in the coat to form a polyimide film; and
removing the particles.
